(19) United States
(12) Patent Application Publication
(10) Pub. No.: US 2013/0142114 A1
(43) Pub. Date: Jun. 6, 2013

(54) Enhancement of Replay Protection in Wireless Communication Systems

(71) Applicant: Qualcomm Incorporated, San Diego, CA (US)

(72) Inventors: Jan C. Ault, San Diego, CA (US); Patrick Lim, San Diego, CA (US); Fangqi Hu, San Diego, CA (US); Kuo-Chun Lee, San Diego, CA (US)

(73) Assignee: QUALCOMM INCORPORATED, San Diego, CA (US)

(21) Appl. No.: 13/646,092

(22) Filed: Oct. 5, 2012

Related U.S. Application Data
(60) Provisional application No. 61/567,024, filed on Dec. 5, 2011.

(51) Int. Cl. H04W 4/00

(52) U.S. Cl. 370/328

(57) ABSTRACT

Certain aspects of the present disclosure generally relate to methods and apparatus for enhancement of replay protection between receivers and transmitters from third party interveners in wireless communication systems. One example method generally includes transmitting one or more packets, wherein each of the packets comprises an indication of a packet number associated with that packet; determining that a condition has been met or exceeded; and based on the determination, transmitting a message indicating a packet number increase. Another example method generally includes receiving a first packet comprising an indication of a first packet number; receiving a message indicating a packet number increase; updating a packet number window based on the packet number increase; after the updating, receiving a second packet comprising an indication of a second packet number; and discarding at least a portion of the second packet if the second packet number is outside the packet number window.

### CROSS-REFERENCE TO RELATED APPLICATIONS

This application claims benefit of U.S. Provisional Patent Application Ser. No. 61/567,024, entitled “Enhancement of Replay Protection in Mobile WiMAX Systems” and filed Dec. 5, 2011, which is herein incorporated by reference.

### TECHNICAL FIELD

Certain aspects of the present disclosure generally relate to wireless communications and, more particularly, to replay protection from third parties in wireless communication systems.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is LTE. LTE is a set of enhancements to the Universal Mobile Telecommunications System (UMTS) mobile standard promulgated by Third Generation Partnership Project (3GPP). It is designed to better support mobile broadband Internet access by increasing spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

OFDM and OFDMA wireless communication systems, under the 3GPP LTE or the Institute of Electrical and Electronics Engineers (IEEE) 802.16 family of standards (also known as WiMAX), for example, use a network of base stations (or evolved Node B (eNBs)) to communicate with wireless devices (also known as mobile stations or user equipment (UE)) registered for services in the systems based on the orthogonality of frequencies of multiple subcarriers and can be implemented to achieve a number of technical advantages for wideband wireless communications, such as resistance to multipath fading and interference. Each base station emits and receives radio frequency (RF) signals that convey data to and from the wireless devices.

As for the data being conveyed, a third-party intervener (TPI) may intercept (i.e., eavesdrop on) a legitimate packet sent between the MS and the BS and may replay the packet at a later time, which is known as a replay attack. Data replay protection attempts to prevent these types of attacks and to ensure that the same data is not delivered multiple times (i.e., that the data is received once, and only once). Replay detection mechanisms attempt to detect whether a received data frame is an unauthorized retransmission. In typical data replay protection schemes, the sender typically assigns a monotonically increasing packet number (PN) to each packet, and the receiver rejects packets with smaller sequence numbers than it has already seen.

### SUMMARY

Certain aspects of the present disclosure generally relate to enhancing replay protection from third parties in wireless communication systems.

Certain aspects of the present disclosure provide a method for wireless communications from the perspective of a wireless device (e.g., a mobile station (MS) or user equipment (UE)). The method generally includes transmitting one or more packets, wherein each of the packets comprises an indication of a packet number associated with that packet; determining that a condition has been met or exceeded; and based on the determination, transmitting a message indicating a packet number increase.

Certain aspects of the present disclosure provide a method for wireless communications from the perspective of a base station (BS) or evolved Node B (eNB). The method generally includes receiving a first packet comprising an indication of a first packet number; receiving a message indicating a packet number increase; updating a packet number window based on the packet number increase; after the updating, receiving a second packet comprising an indication of a second packet number; and discarding at least a portion of the second packet if the second packet number is outside the packet number window.

Certain aspects of the present disclosure provide an apparatus for wireless communications. The apparatus generally includes means for transmitting one or more packets, wherein each of the packets comprises an indication of a packet number associated with that packet; means for determining that a condition has been met or exceeded, and means for transmitting, based on the determination, a message indicating a packet number increase.

Certain aspects of the present disclosure provide an apparatus for wireless communications. The apparatus generally includes means for receiving a first packet comprising an indication of a first packet number, means for receiving a message indicating a packet number increase, means for updating a packet number window based on the packet number increase, means for receiving, after the updating, a second packet comprising an indication of a second packet number, and means for discarding at least a portion of the second packet if the second packet number is outside the packet number window.

Certain aspects of the present disclosure provide an apparatus for wireless communications. The apparatus generally includes a transmitter and a processing system. The transmitter is typically configured to transmit one or more packets, wherein each of the packets comprises an indication of a packet number associated with that packet. The processing system is generally configured to determine that a condition has been met or exceeded. The transmitter is further configured to transmit, based on the determination, a message indicating a packet number increase.

Certain aspects of the present disclosure provide an apparatus for wireless communications. The apparatus generally includes a receiver and a processing system. The receiver is typically configured to receive a first packet comprising an indication of a first packet number and to receive a message indicating a packet number increase. The processing system is generally configured to update a packet number window based on the packet number increase. The receiver is further configured to receive, after the updating, a second packet comprising an indication of a second packet number. The processing system is further configured to discard at least a portion of the second packet if the second packet number is outside the packet number window.

Certain aspects of the present disclosure provide a computer program product for wireless communications including a computer-readable medium having instructions stored thereon. The instructions are generally executable by one or more processors for enhancing replay protection from third parties in wireless communication systems from the perspective of a wireless device. The method generally includes transmitting one or more packets, wherein each of the packets comprises an indication of a packet number associated with that packet; determining that a condition has been met or exceeded; and based on the determination, transmitting a message indicating a packet number increase.

Certain aspects of the present disclosure provide a computer program product for wireless communications including a computer-readable medium having instructions stored thereon. The instructions are generally executable by one or more processors for receiving a first packet comprising an indication of a first packet number; receiving a message indicating a packet number increase; updating a packet number window based on the packet number increase; after the updating, receiving a second packet comprising an indication of a second packet number; and discarding at least a portion of the second packet if the second packet number is outside the packet number window.

### BRIEF DESCRIPTION OF THE DRAWINGS

So that the manner in which the above recited features of the present disclosure can be understood in detail, a more particular description, briefly summarized above, may be had by reference to various aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example wireless communication system, in accordance with an aspect of the present disclosure.

FIG. 2 illustrates various components that may be utilized in a wireless device, in accordance with an aspect of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology, in accordance with an aspect of the present disclosure.

FIG. 4 illustrates an example scenario where a third party intervener (TPI) intercepts a MAC Protocol Data Unit (MPDU) sent from a mobile station (MS) intended to be received by a base station (BS) and subsequently transmits a replayed transmission to the BS, in accordance with an aspect of the present disclosure.

FIG. 5 illustrates an example scenario where a TPI intercepts a set of MPDUs sent from an MS intended to be received by a BS and subsequently transmits replayed transmissions to the BS, in accordance with an aspect of the present disclosure.

FIG. 6 is a flow diagram of example operations for enhancing the replay protection between an MS and a BS from TPIs in wireless communication systems from the perspective of the MS, in accordance with an aspect of the present disclosure.

FIG. 7 is a flow diagram of example operations for enhancing the replay protection between an MS and a BS from TPIs in wireless communication systems from the perspective of the BS, in accordance with an aspect of the present disclosure.

FIG. 8 illustrates an example scenario where an MPDU is sent to a BS when the TPI temporarily fails to block packets from the MS to the BS, in accordance with an aspect of the present disclosure.

FIG. 9 illustrates an example scenario where an MS transmits a request to a BS to increase the allowable packet number (PN) window upon reaching a delay time threshold, in accordance with an aspect of the present disclosure.

FIG. 10 illustrates an example timeline where an MS transmits a request to a BS to increase the allowable PN window upon reaching a delay time threshold from the perspective of the BS, in accordance with an aspect of the present disclosure.

FIG. 11 illustrates an example scenario where a BS transmits a request to an MS to send an empty MPDU containing a new PN value when a certain amount of time has elapsed since the last received transmission, in accordance with an aspect of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different wireless technologies, system configurations, networks and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The methods and apparatus of the present disclosure may be utilized in a broadband wireless communication system. The term “broadband wireless” refers to technology that provides wireless, voice, video, Internet, and/or data network access over a given area.

WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX offers the full mobility of cellular networks at broadband speeds.

Mobile WiMAX is based on OFDM and OFDMA technology. OFDM is a digital multi-carrier modulation technique that has recently found wide adoption in a variety of high-data-rate communication systems. With OFDM, a transmit bit stream is divided into multiple lower-rate substreams. Each substream is modulated with one of multiple orthogonal subcarriers and sent over one of a plurality of parallel subchannels. OFDMA is a multiple access technique in which users are assigned subcarriers in different time slots. OFDMA is a flexible multiple-access technique that can accommodate many users with widely varying applications, data rates, and quality of service requirements.

The rapid growth in wireless internets and communications has led to an increasing demand for high data rate in the field of wireless communications services. OFDM/OFDMA systems are today regarded as one of the most promising research areas and as a key technology for the next generation of wireless communications. This is due to the fact that OFDM/OFDMA modulation schemes can provide many advantages such as modulation efficiency, spectrum efficiency, flexibility, and strong multipath immunity over conventional single carrier modulation schemes.

IEEE 802.16x is an emerging standard organization to define an air interface for fixed and mobile broadband wireless access (BWA) systems. IEEE 802.16x approved “IEEE P802.16-REVd/D5-2004” in May 2004 for fixed BWA systems and published “IEEE P802.16e/D12 October 2005” in October 2005 for mobile BWA systems. Those two standards defined four different physical layers (PHYs) and one Media Access Control (MAC) layer. The OFDM and OFDMA physical layer of the four physical layers are the most popular in the fixed and mobile BWA areas respectively.

As those skilled in the art will readily appreciate from the detailed description to follow, the various concepts presented herein are well suited for WiMAX applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employ CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), UMB, IEEE 802.11 (Wi-Fi), Long Term Evolution (LTE), IEEE 802.20, and Flash-OFDM employing OFDMA. UTRA, E-UTRA, UMTS, LTE, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

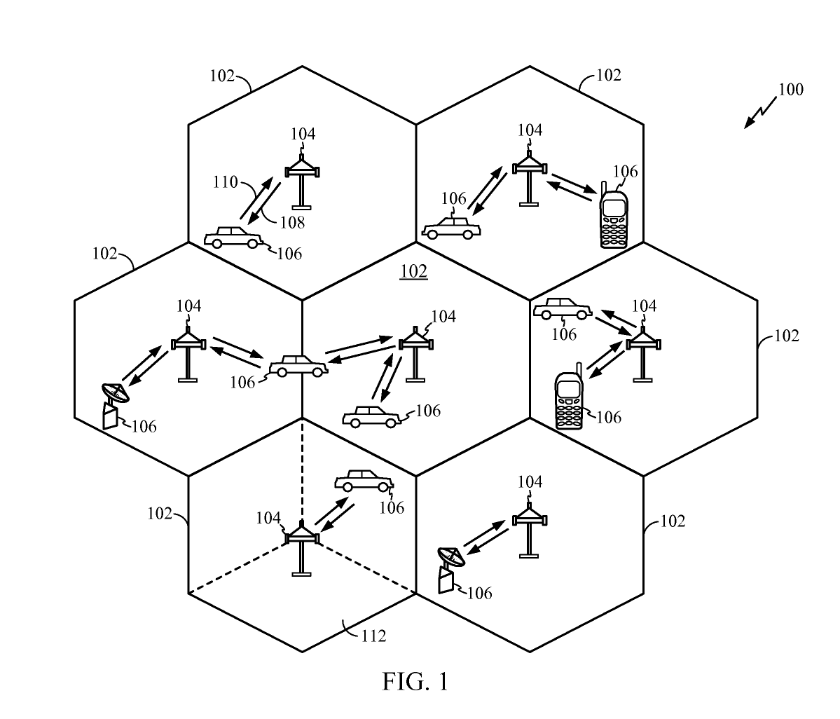

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point (AP), a Node B, an evolved Node B (eNB), or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations (MSs), stations, user equipment (UE), etc. The user terminals 106 may be wireless devices, such as cellular phones, smart phones, personal digital assistants (PDAs), handheld devices, wireless modems, laptop computers, personal computers, tablets, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system. The wireless communication system 100 may also use SC-FDMA for transmissions between the base stations 104 and the user terminals 104, such as uplink transmissions from a user terminal 106 to a base station 104.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

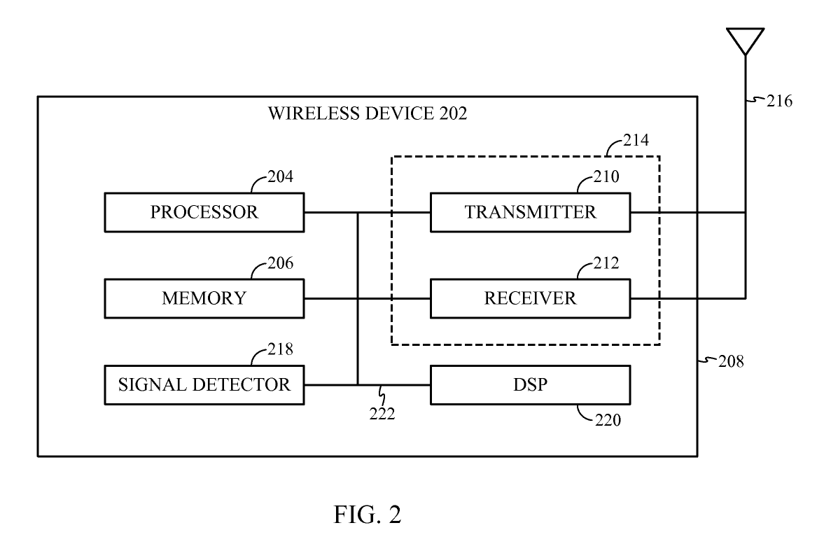

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

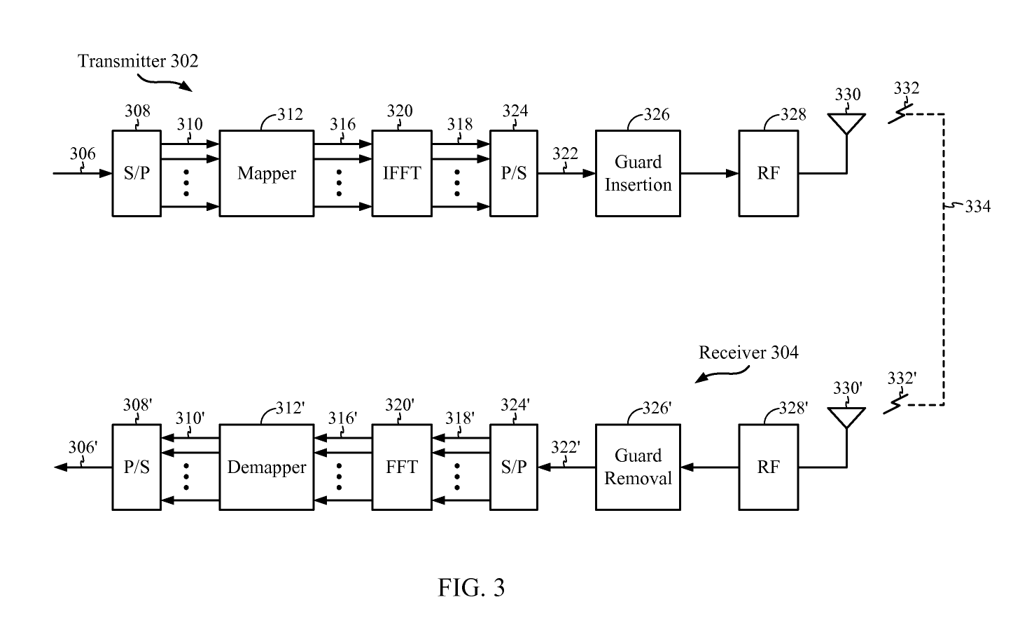

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8 PSK), quadrature amplitude modulation (QAM), etc. Thus, the mapper 312 may output N parallel symbol streams 316, each symbol stream 316 corresponding to one of the N orthogonal subcarriers of an inverse fast Fourier transform (IFFT). These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### Example Network Security Standards

Aspects of the present disclosure apply to any of various suitable wireless communication standards, such as WiMAX and LTE, and analogies may be drawn between various standard-specific terms. For example, a packet number (PN) in WiMAX is analogous to a sequence number (SN) in LTE, and a MAC Protocol Data Unit (MPDU) in WiMAX is akin to a Physical Data Convergence Protocol (PDCP) Protocol Data Unit (PPDU) in LTE. Furthermore, aspects of the present disclosure may apply to a packet in any Open Systems Interconnection (OSI) layer, not just the Media Access Control (MAC) layer (a sublayer of layer 2, also known as the data link layer). However, for ease of description, the present disclosure will use WiMAX terminology henceforth.

Certain versions of WiMAX utilize IEEE 802.16 wireless network standards that provide Privacy and Key Management (PKM) protocols for security features, including: (1) encryption, authentication, and data replay protection for the data plane (DP); and (2) authentication and data replay protection for the control plane (CP).

In data replay protection, each MPDU of the DP or CP has a 4-byte PN field. On the DP, data replay protection is per security association (SA). Each SA in the DP operates independently and includes one or more transport connections. The sender may increment the PN for any MPDU of the transport connections for each SA, and the receiver may provide a PN window update and a received PN check for each SA separately.

The sender may increment the PN of every DP MPDU with user data per SA, starting from zero for DL or 0x80000000 for UL. When the PN is incremented close to the maximum value (e.g., 0x7FFFFFFF for DL or 0xFFFFFFFF for UL), the traffic key request procedure may most likely restart. The receiver may provide a shifting PN window of PN numbers, say [n−L+1, n], indicating the allowable PN of the received MPDU. The parameter L is the window size.

When a DP MPDU is received with PN=n′ larger than the window (i.e., n′>n), then the allowable PN window is updated to become [n′−L+1, n′]. The receiver may keep a flag for each PN status within the window. The flag may be set to “Received” when a DP MPDU is first received. An MPDU with PN=n′ is considered as replayed data and may most likely be discarded if either of the following conditions is true: (1) PN=n′ is smaller than this window (i.e., n′<n−L+1); or (2) the received MPDU with PN=n′ has been received already (i.e., the flag is set to “Received”).

Similar operations may apply to the CP. However, data replay protection is on a per-MS basis. The sender may increment the PN of the CP MPDU with the MAC management message, starting from zero. The receiver may then maintain a smaller window to perform a received MPDU check similar to the above conditions.

The above two conditions may allow the receiver to check if an MPDU was sent from a third party intervener (TPI) who intercepted and then resent the original MPDU. Even though an MPDU was intercepted by a TPI, the receiver may still have received the original MPDU sent from the MS as well. In this case, the flag would be marked as “Received,” or the current PN would be less than the allowable PN window when the receiver receives the replayed message from the TPI, which may prompt the receiver to discard the replayed data received from the TPI.

The TPI may anticipate this situation and temper the PN to a higher value. If this is to happen, the TPI may need to know the key (traffic key or CMAC key) or have the ability to generate the Integrity Check Value (ICV) or the Cipher-based Message Authentication Code (CMAC) Value using the modified PN value. Otherwise, if the TPI cannot acquire the key or uses the wrong ICV or CMAC value, the data or message authentication check will fail.

However, some security holes may still occur in the current data replay protection scheme. This scheme assumes that the receiver can still receive the original MPDU from the sender. But, if the TPI can completely block MPDUs from being received from the sender, there is some possibility that replay can succeed. Thus, the current forms of replay protection are insufficient in prompting the receiver to discard replayed messages received from the TPI.

### Example Communication System with Third Party Intervention

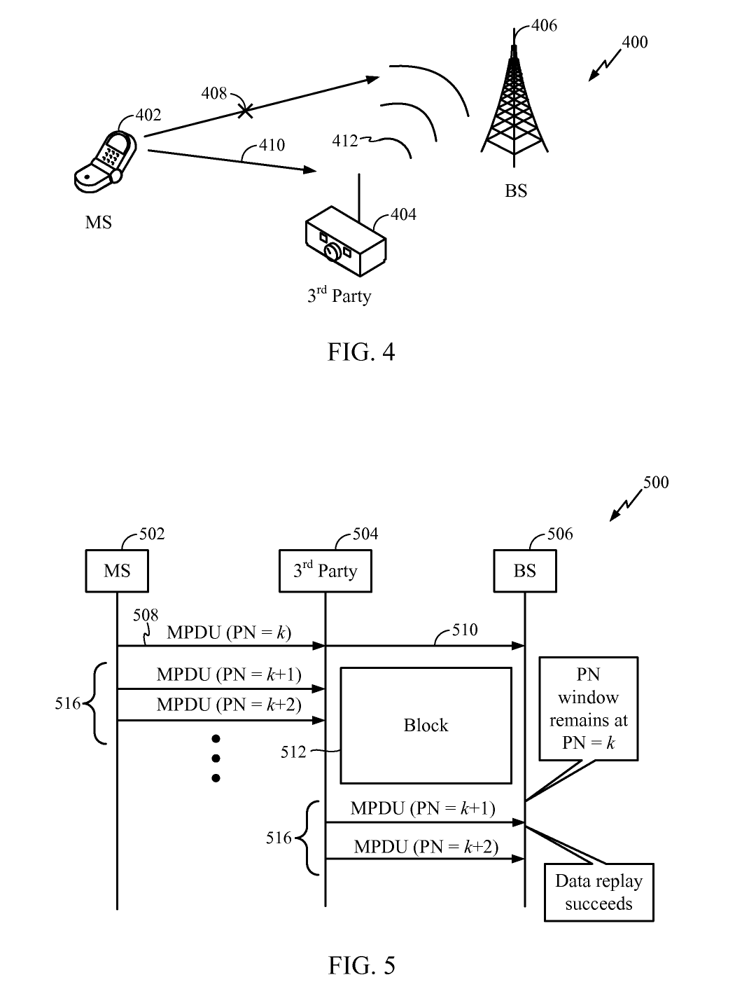

FIG. 4 illustrates an example scenario 400 where a TPI 404 has intercepted the communication between an MS 402 and a BS 406 in a wireless communication system. The MS 402 may intend to transmit MPDUs directly to the BS 406 through data stream 408. However, the TPI 404 may block the data stream 408 (e.g., jam the BS 406 such that the BS cannot receive the MPDUs correctly), intercept the data stream 408 through data stream 410, and retransmit this data and a corresponding PN value to the BS 406 in lieu of the data stream 408 originally intended to be transmitted between the MS 402 and the BS 406. The corresponding PN value sent in the retransmission from the TPI 404 may match the allowable PN value window, in which case the retransmitted data packets 412 from TPI 404 may be successfully transmitted to the BS 406.

Most, if not all, of the data packets transmitted between the MS 402 and the BS 406 may be blocked by the TPI 404 and replaced by the data packets transmitted from the TPI 404 to the BS 406. The method by which the data packets are blocked may be through a radio-jamming procedure or any similar method designed to cease successful data packet transmission between a transmitter and a receiver.

FIG. 5 illustrates an example situation 500 where a set of data packets (e.g., MPDUs) transmitted from an MS 502 to a BS 506 are intercepted by a TPI 504, thereby explaining example scenario 400 in more detail. The MS 502 may intend to send a set of data packets containing a first data packet 508 and subsequent data packets 516 to the BS 506. However, the first data packet 508 may be intercepted by the TPI 504 and retransmitted to the BS 506 via data stream 510. Not realizing the transmission is a retransmitted copy of the original transmission sent by the MS 502, the BS 506 may accept the transmission, assuming it as the original. After the TPI 504 has intercepted the first data packet 508, data packets 516 subsequently transmitted from the MS 502 may be blocked at 512 by the TPI 504 from being received by the BS 506 such that the blocked data packets 516 do not reach the BS 506, at least not without retransmission by the TPI 504. Following the retransmission of the first data packet 508 via data stream 510, the TPI 504 may then retransmit the blocked data packets 516 to the BS 506 so, from the perspective of the BS 506, it may seem that no intervention has occurred in the first place.

### Example Replay Protection

As previously described, certain aspects of the present disclosure provide techniques and apparatus that may further enhance the replay protection, for example, between an MS and a BS from TPIs in wireless communication systems.

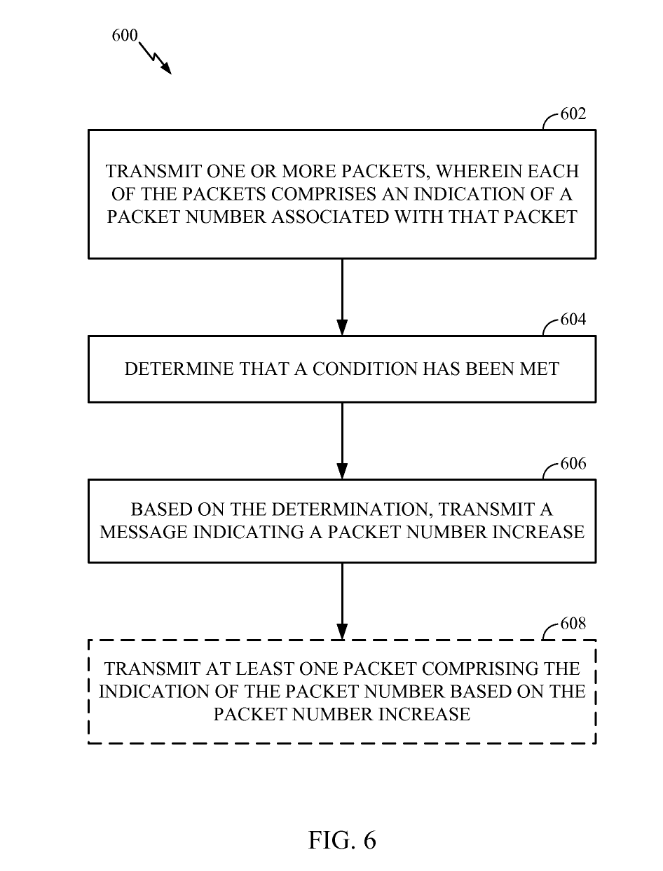

FIG. 6 is a flow diagram of example operations 600 for enhancing the replay protection between an MS and a BS from TPIs in wireless communication systems from the perspective of the MS. The operations 600 may be performed by any suitable wireless device. Thus, the operations 600 may be understood with reference to FIG. 4 which illustrates an example situation where the TPI 404 may intercept most, if not all, of the data packets transmitted from the MS 402 to the BS 406.

The operations 600 may begin, at 602, where the MS may transmit one or more packets, wherein each of the packets comprises an indication of a packet number associated with that packet. At step 604, the MS may then determine whether a condition has been met or exceeded. For example, the MS may determine that the TPI has failed to completely block transmitted data packets for an amount of time at least long enough to successfully transmit a request for a packet number increase.

Based on that determination, at step 606, the MS may then transmit a message indicating a packet number increase. The number increased may be determined by randomly selecting a number. At step 608, the MS may finally transmit at least one packet comprising the indication of the packet number based on the packet number increase.

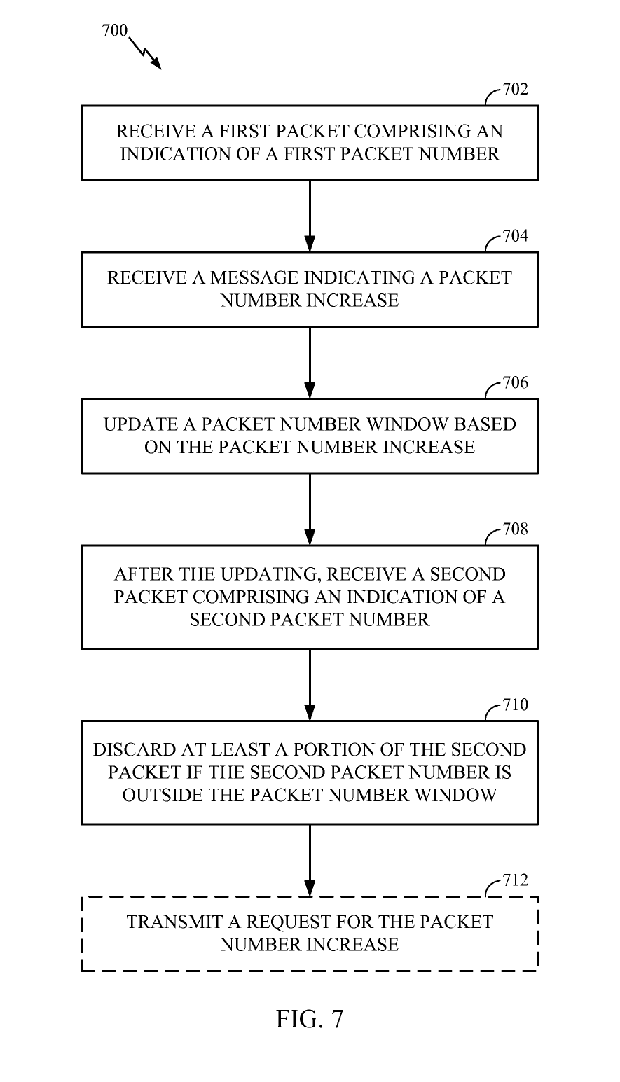

FIG. 7 is a flow diagram of example operations 700 for enhancing the replay protection between an MS and a BS from TPIs in wireless communication systems from the perspective of the BS. The operations 700 may be performed by any suitable base station. Thus, the operations 700 may be understood with reference to FIG. 4 which illustrates an example situation where the TPI 404 may intercept most, if not all, of the data packets transmitted from the MS 402 to the BS 406.

The operations 700 may begin, at 702, where the BS may receive a first packet comprising an indication of a first packet number. At step 704, the BS may receive a message indicating a packet number increase and, subsequently at step 706, update a packet number window based on the packet number increase. After the updating, at step 708, the BS may receive a second packet comprising an indication of a second packet number. At step 710, the BS may then discard at least a portion of the second packet if the second packet number is outside the packet number window. Finally, at step 712, the BS may transmit a request for the packet number increase.

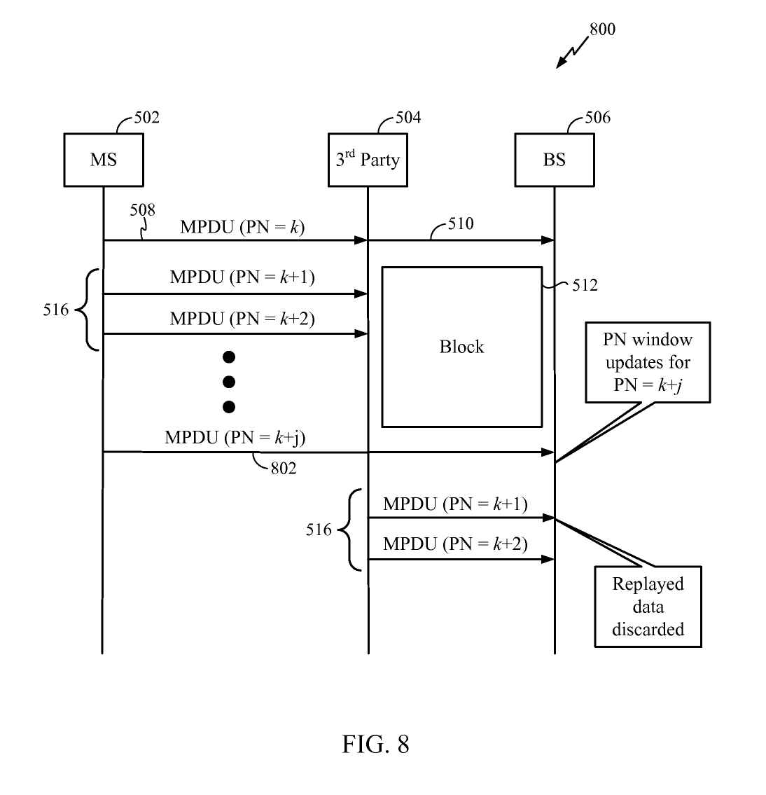

As described above, the most vulnerable time for the receiver (e.g., the BS 506) is where the window stalls when and after the third party blocks the receiver while the packets (e.g., MPDUs) are intercepted. Then the third party can resend these intercepted packets to the receiver without being detected. Since the receiver PN window remains the same, the receiver may accept all of the replayed packets. Alternatively, the receiver may momentarily receive one or more authentic packets when the third party does not block and consequently may update the allowable PN window. When the third party resends the intercepted packets, the receiver may have already shifted the allowable PN window, and then the replayed packets will be smaller than the PN window and are discarded, as illustrated in FIG. 8.

FIG. 8 illustrates an example situation 800 where a set of data packets (e.g., MPDUs) is sent to the BS 506 when the TPI 504 temporarily fails to block packets from the MS 502 to the BS 506. The MS 502 may intend to send a set of data packets containing the first data packet 508 and subsequent transmissions of data packets 516 to the BS 506. However, the first data packet 508 may be intercepted by the TPI 504 and retransmitted to the BS 506 through data stream 510. Not realizing the transmission is a retransmitted copy of the original transmission sent by the MS 502, the BS 506 may accept the transmission assuming it as the original. After the TPI has intercepted the first data packet 508, data packets 516 subsequently transmitted from the MS 502 may be blocked at 512 by the TPI 504 from being received by the BS 506 such that the blocked data packets 516 do not reach the BS 506, at least not without retransmission by the TPI 504.

The TPI 504, however, may fail to block every subsequent data packet sent from the MS 502 to the BS 506. Given this situation, the MS 502 may detect this gap in blockage and transmit an empty MPDU 802 containing a request to increase the allowable PN window by a certain value (PN Jump Request) to the BS 506. For example, the MS 502 may detect this blockage gap by measuring a reduced radio frequency (RF) jamming from the TPI 504 or no acknowledgment from the BS 506. The gap in blockage by the TPI 504 allows the PN Jump Request 804 to transmit to the BS without the TPI 504 noticing any such transmission. Once the BS 506 receives the empty MPDU 802 with the PN Jump Request, the BS may then increase the allowable PN window accordingly.

Following the retransmission of data stream 510 of the first data packet 508, the TPI 504 may then retransmit the blocked data packets 516 to the BS 506. However, due to the fact that the BS 506 has already received and acted upon the PN Jump Request, the blocked data packets 516 retransmitted to the BS 506 may possess PN number values that do not correspond to the allowable PN window (in this example situation 800, PN number values smaller than the allowable PN window). Once the BS 506 detects this discrepancy, the blocked data packets 516 retransmitted from the TPI 504 may then be discarded.

### Unsolicited PN Jump

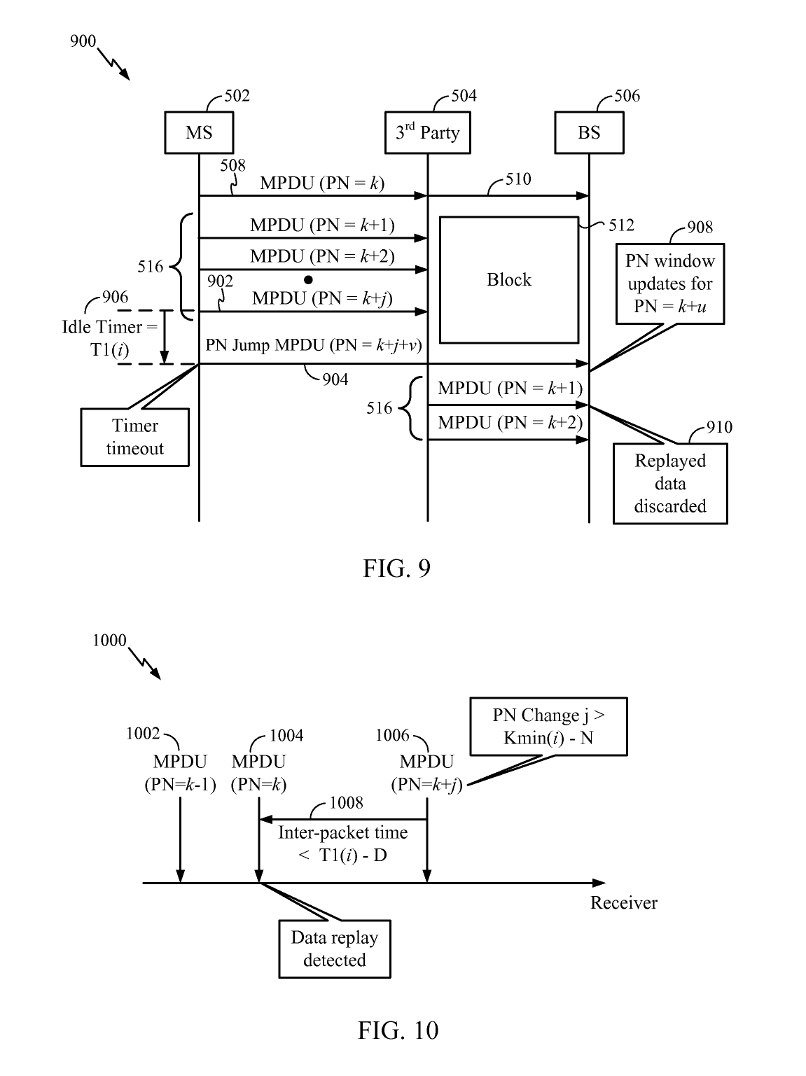

FIG. 9 illustrates an example situation 900 where the MS 502 transmits a request to the BS 506 to increase the allowable PN window upon reaching a delay time threshold from which time accrues starting from the end of the last transmission. The MS 502 may intend to send a set of data packets (e.g., MPDUs) containing the first data packet 508 and subsequent transmissions of data packets 516 to the BS 506. However, the first data packet 508 may be intercepted by the TPI 504 and retransmitted to the BS 506 through data stream 510. Not realizing the transmission is a retransmitted copy of the original transmission sent by the MS 502, the BS 506 may accept the transmission assuming it as the original. After the TPI 504 has intercepted the first data packet 508, data packets 516 subsequently transmitted from the MS 502 may be blocked at 512 by the TPI 504 from being received by the BS 506 such that the blocked data packets 516 do not reach the BS 506 without retransmission by the TPI 504.

The MS 502 may be capable of detecting the elapsed time since the last transmission through idle timers 906 represented by t1(i), where i=0, . . . , M, for the CP and each SA of the DP. For example, if there are 3 SAs for an MS, then there will be four timers independently operating (e.g., one timer for the CP and three timers for the SAs).

If the idle timer 906 detects a delay time greater than or equal to a threshold value T1(i) since the last transmission 902 with PN=u(i), the MS 502 may send the BS 506 an unsolicited PN Jump packet 904 with PN=u(i)+v where v is a value randomly selected in a range [Kₘᵢₙ(i), Kₘₐₓ(i)], where Kₘₐₓ(i) and Kₘᵢₙ(i), i=0, . . . , M, are the maximum and minimum value of this range which can depend on the CP and the SAs of the DP. The random number may be used to avoid the third party being able to know the PN jump if the jump was deterministic. The TPI 504 most likely does not jam the BS 506 when sending the blocked data packets 516, such that the PN Jump packet 904 transmitted by the MS 502 is not blocked and may actually reach the BS 506 during these non-jamming intervals. Once the BS 506 receives the PN Jump packet 904, the BS may then increase the allowable PN window accordingly at 908.

A dummy MPDU (e.g., the PN Jump packet 904) may be an MPDU of a transport connection for an SA without any user data or an MPDU of a Primary Management connection without any message. However, it may have the ability to carry the packet number jump to update the allowable PN window at the receiver.

Following the retransmission of data stream 510 of the first data packet 508, the TPI 504 may then retransmit the blocked data packets 516 to the BS 506. However, due to the fact that the BS 506 has already received and acted upon the request to increase the allowable PN window from the unsolicited PN Jump packet 904, the blocked data packets 516 retransmitted to the BS 506 may possess PN number values that do not correspond to the allowable PN window (in this example situation 900, PN number values smaller than the allowable PN window). Once the BS 506 detects this discrepancy, the blocked data packets 516 retransmitted from the TPI 504 may then be discarded at 910.

Since the receiver can know when the sender can send unsolicited PN Jump packets (i.e., PN Jump MPDUs not triggered by a PN Jump Request Message transmitted from the receiver, as described below), the receiver (e.g., the BS 506) may use the following conditions to detect data replay retrospectively: (1) PN number change of two received MPDUs of the context index i (i.e., the same SA or CP) is more than a threshold Kₘᵢₙ(i)−N, where N is some margin to allow the scheme to work even if some replayed data were received; and (2) the inter-packet time between the two consecutive MPDUs being received is less than a threshold T1(i)−D, where D must be more than the maximum transmission delay. Condition 1 detects that a PN Jump MPDU has been received, whereas condition 2 verifies that the time interval is a little shorter than the idle timer at the sender. This retrospective check procedure is depicted in FIG. 10.

FIG. 10 illustrates an example timeline 1000 from the perspective of the BS 506 for an unsolicited PN jump scenario where the MS 502 transmits a PN Jump MPDU to the BS 506 upon reaching a delay time threshold from which time accrues starting from the end of the last received transmission. In one aspect of the present disclosure, MPDUs 1002, 1004, and 1006 are received by the BS 506. When the MPDU 1006 is received by the BS 506, the BS 506 may determine that the PN change from the previously received MPDU 1004 is more than a threshold Kₘᵢₙ(i)−N, such that MPDU 1006 is a PN Jump MPDU. Based on this, the BS 506 may determine the elapsed time 1008 since the previously received MPDU 1004. If the elapsed time 1008 is less than T1(i)−D, the BS 506 may then utilize this information and discard all transmissions received within a period of T1(i)−D before the PN Jump MPDU (i.e., MPDU 1006). Transmissions received during this period may likely be unwanted retransmitted data from the TPI 504.

### Solicited PN Jump

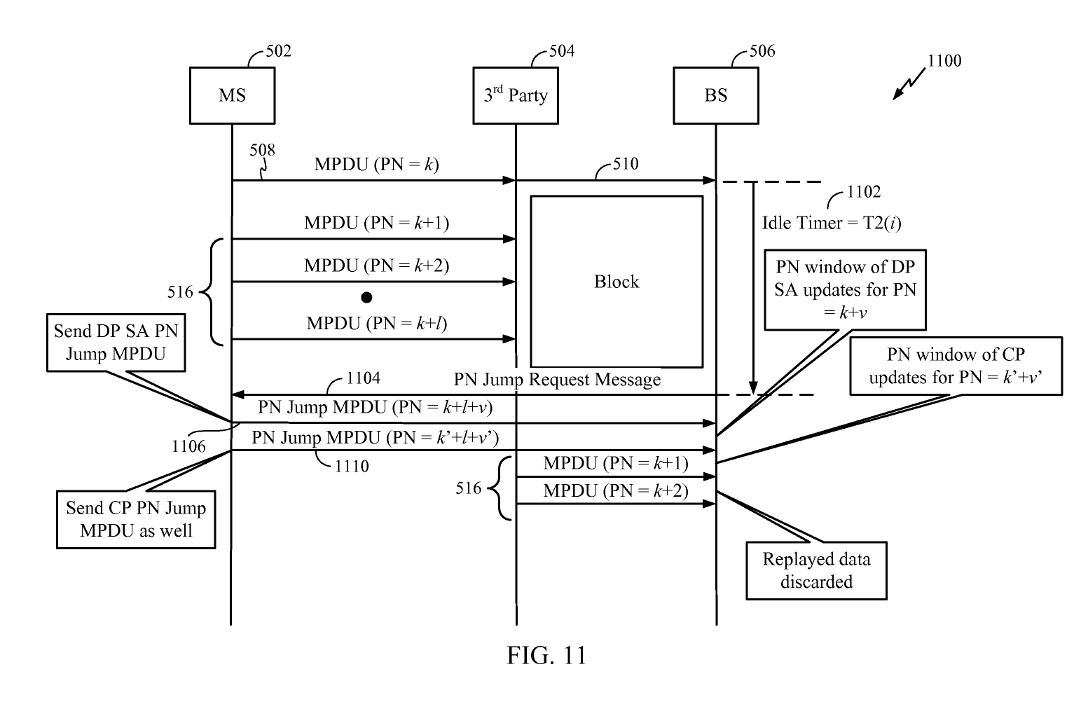

FIG. 11 illustrates an example situation 1100 where the BS 506 transmits a request to the MS 502 to send an empty MPDU containing a new PN value (PN Jump Value) when a certain amount of time has elapsed since the last received transmission. The BS 506 may increase the allowable PN window corresponding to the PN Jump Value. The MS 502 may intend to send a set of data packets (e.g., MPDUs) containing the first data packet 508 and subsequent transmissions of data packets 516 to the BS 506. However, the first data packet 508 may be intercepted by the TPI 504 and retransmitted to the BS 506 through data stream 510. Not realizing the transmission is a retransmitted copy of the original transmission sent by the MS 502, the BS 506 may accept the transmission assuming it as the original. After the TPI has intercepted the first data packet 508, data packets 516 subsequently transmitted from the MS 502 may be blocked at 512 by the TPI 504 from being received by the BS 506 such that the blocked data packets 516 do not reach the BS 506, at least not without retransmission by the TPI 504.

The BS 506 may be capable of monitoring the received MPDUs per the CP and per SA of the DP and detecting the amount of time elapsed since the last received transmission with PN=u(i) through idle timers 1102 represented by T2(i), i=0, 1, . . . , M, for the CP and each SA of the DP. If the idle timer 1102 detects a delay time greater than or equal to a threshold value (T2(i)) since the last received transmission of data stream 510, the BS 506 may immediately send a request 1104 to the MS 502 requesting a PN Jump Value (Packet Number Jump Request Message). The TPI 504 most likely does not perform RF jamming when retransmitting the blocked data packets 516, such that the PN Jump Request Message 1104 sent by the BS 506 is not blocked and may get through to the MS 502. Upon receiving a Packet Number Jump Request Message 1104, the MS 502 may transmit a DP SA PN Jump MPDU 1106 with PN=u(i)+l+v and a CP PN Jump MPDU 1110 with PN=u(i)′+l+v′ to the BS 506. For example, if there are 3 SAs, then the sender may send four PN Jump MPDUs with individual PN jump values set randomly according to the rule mentioned above. The TPI 504 most likely does not jam the BS 506 when retransmitting the blocked data packets 516, such that the PN Jump MPDUs 1106, 1110 transmitted by the MS 502 are not blocked and may actually reach the BS 506 during these non-jamming intervals. Once the BS 506 receives the PN Jump MPDUs 1106, 1110, the BS 506 may then increase the allowable PN window accordingly.

Following the retransmission of data stream 510 of the first data packet 508, the TPI 504 may then retransmit the blocked data packets 516 to the BS 506. However, due to the fact that the BS 506 has already increased the allowable PN window from the solicited PN Jump Values for the DP and CP, the blocked data packets 516 retransmitted to the BS 506 may possess PN number values that do not correspond to the allowable PN window, in this case PN number values smaller than the allowable PN window. Once the BS 506 detects this discrepancy, the blocked data packets 516 retransmitted from the TPI 504 may then be discarded.

While the techniques presented herein have been described with reference to WiMAX, those skilled in the art will appreciate that the techniques may be applied to similar effect in a variety of different types of wireless networks, as described above.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal or other wireless node, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications, comprising:
transmitting one or more packets, wherein each of the packets comprises an indication of a packet number associated with that packet;
determining that a condition has been met; and
based on the determination, transmitting a message indicating a packet number increase.

2. The method of claim 1, wherein the indication of the packet number comprises a 4-byte packet number field.

3. The method of claim 1, wherein the determining comprises determining that a time since the last of the packets was transmitted has met or exceeded a threshold.

4. The method of claim 1, further comprising randomly selecting the packet number increase.

5. The method of claim 1, wherein the message indicating the packet number increase comprises a media access control (MAC) protocol data unit (MPDU) of a transport connection for a security association (SA) without any data or an MPDU of a primary management connection without any messages.

6. The method of claim 1, wherein the determining comprises receiving a request for the packet number increase.

7. The method of claim 1, further comprising transmitting at least one packet comprising the indication of the packet number based on the packet number increase.

8. The method of claim 1, wherein the one or more packets is transmitted after determining that a time since the first packet was received has met or exceeded a threshold.

9. A method for wireless communications, comprising:
receiving a first packet comprising an indication of a first packet number;
receiving a message indicating a packet number increase;
updating a packet number window based on the packet number increase;
after the updating, receiving a second packet comprising an indication of a second packet number; and
discarding at least a portion of the second packet if the second packet number is outside the packet number window.

10. The method of claim 9, wherein the indication of the first or second packet number comprises a 4-byte packet number field.

11. The method of claim 9, wherein the message indicating the packet number increase comprises a media access control (MAC) protocol data unit (MPDU) of a transport connection for a security association (SA) without any data or an MPDU of a primary management connection without any messages.

12. The method of claim 9, further comprising transmitting a request for the packet number increase.

13. An apparatus for wireless communications, comprising:
means for transmitting one or more packets, wherein each of the packets comprises an indication of a packet number associated with that packet;
means for determining that a condition has been met; and
means for based on the determination, transmitting a message indicating a packet number increase.

14. The apparatus of claim 1, wherein the indication of the packet number comprises a 4-byte packet number field.

15. The apparatus of claim 1, wherein the means for determining comprises means for determining that a time since the last of the packets was transmitted has met or exceeded a threshold.

16. The apparatus of claim 1, further comprising means for randomly selecting the packet number increase.

17. The apparatus of claim 1, wherein the message indicating the packet number increase comprises a media access control (MAC) protocol data unit (MPDU) of a transport connection for a security association (SA) without any data or an MPDU of a primary management connection without any messages.

18. The apparatus of claim 1, wherein the means for determining comprises means for receiving a request for the packet number increase.

19. The apparatus of claim 1, further comprising means for transmitting at least one packet comprising the indication of the packet number based on the packet number increase.

20. The apparatus of claim 1, wherein the one or more packets is transmitted after determining that a time since the first packet was received has met or exceeded a threshold.

21. An apparatus for wireless communications, comprising:
means for receiving a first packet comprising an indication of a first packet number;
means for receiving a message indicating a packet number increase;
means for updating a packet number window based on the packet number increase;
means for receiving, after the updating, a second packet comprising an indication of a second packet number; and
means for discarding at least a portion of the second packet if the second packet number is outside the packet number window.

22. The apparatus of claim 21, wherein the indication of the first or second packet number comprises a 4-byte packet number field.

23. The apparatus of claim 21, wherein the message indicating the packet number increase comprises a media access control (MAC) protocol data unit (MPDU) of a transport connection for a security association (SA) without any data or an MPDU of a primary management connection without any messages.

24. The apparatus of claim 21, further comprising means for transmitting a request for the packet number increase.

25. An apparatus for wireless communications, comprising:
a transmitter configured to transmit one or more packets, wherein each of the packets comprises an indication of a packet number associated with that packet; and
a processing system configured to determine that a condition has been met, wherein the transmitter is further configured to transmit, based on the determination, a message indicating a packet number increase.

26. An apparatus for wireless communications, comprising:
a receiver configured to:
receive a first packet comprising an indication of a first packet number; and
receive a message indicating a packet number increase; and
a processing system configured to:
update a packet number window based on the packet number increase, wherein the receiver is further configured to receive, after the updating, a second packet comprising an indication of a second packet number; and
discard at least a portion of the second packet if the second packet number is outside the packet number window.

27. A computer program product comprising a computer-readable medium having instructions stored thereon, the instructions generally executable by one or more processors for:
transmitting one or more packets, wherein each of the packets comprises an indication of a packet number associated with that packet;
determining that a condition has been met; and
based on the determination, transmitting a message indicating a packet number increase.

28. A computer program product comprising a computer-readable medium having instructions stored thereon, the instructions generally executable by one or more processors for:
receiving a first packet comprising an indication of a first packet number;
receiving a message indicating a packet number increase;
updating a packet number window based on the packet number increase;
receiving, after the updating, a second packet comprising an indication of a second packet number; and
discarding at least a portion of the second packet if the second packet number is outside the packet number window.
